(19) United States
(12) Patent Application Publication
(10) Pub. No.: US 2018/0262389 A1
(43) Pub. Date: Sep. 13, 2018

(54) ADVERTISING METHOD AND SYSTEM IN NETWORK FUNCTIONS VIRTUALIZATION ENVIRONMENT

(71) Applicant: NOKIA SOLUTIONS AND NETWORKS OY, Espoo (FI)

(72) Inventors: Jani Olavi SODERLUND, Vantaa (FI); Niko Markus SAVOLAINEN, Kerava (FI); Tommy Johannes LINDGREN, Espoo (FI); Tomi Goran WECKSTROM, Helsinki (FI)

(21) Appl. No.: 15/761,249

(22) PCT Filed: Sep. 21, 2015
(86) PCT No.: PCT/EP2015/071532

§ 371 Date: Mar. 19, 2018

(51) Int. Cl. H04L 12/24; H04L 29/12; H04L 12/947; G06F 9/455

(52) U.S. Cl. CPC H04L 41/0803; H04L 61/2007; G06F 2009/45595; G06F 9/45558; H04L 61/6068; H04L 49/25

(57) ABSTRACT

A method includes configuring an IP subnet at an operations support system in a telecommunications network, the operations support system configured for managing at least one virtual networking function; configuring the IP subnet for use by the at least one virtual networking function, the virtual networking function including at least one virtual machine; configuring the IP subnet for use by the least one virtual machine, the at least one virtual machine including a processor and a memory; sending, from the at least one virtual machine, IP subnet data to a virtual networking function manager having a processor and a memory; and sending, from the virtual networking function manager, the IP subnet data to a virtual infrastructure manager configured for managing internal and external connectivity of the IP subnet data.

### FIELD OF TECHNOLOGY

This disclosure relates generally to the field of wireless communication networks, and more specifically, to the Network Function Virtualization (NFV) architecture.

### BACKGROUND

In the telecommunications network industry, the emerging framework known as the Network Function Virtualization (NFV) architecture is referred to as a reference model for future mobile network elements. The NFV architecture can include Virtualized Network Functions (VNF) that require use and advertisement of multiple IP addresses that are dynamically changing.

In 3GPP networks, IP addresses are allocated and routed/advertised on behalf of the user equipment (UE). As known by those having skill in the art, the purpose of UE IP address allocation is to define the IP addresses of a packet-defined network (PDN) connection towards a Gi/SGi network. There are two types of IP address allocation: static and dynamic. In static IP address allocation, the UE or device uses the same IP address each time it connects to the network. In contrast, in dynamic IP address allocation, the IP address is re-allocated for each new PDN connection; in other words, the UE or device does uses a different IP address each time it connects to the network. The present disclosure relates to such dynamic IP address allocation in the NFV environment.

### SUMMARY

A method includes configuring an IP subnet at an operations support system in a telecommunications network, the operations support system configured for managing at least one virtual networking function; configuring the IP subnet for use by the at least one virtual networking function, the virtual networking function including at least one virtual machine; configuring the IP subnet for use by the least one virtual machine, the at least one virtual machine including a processor and a memory; sending, from the at least one virtual machine, IP subnet data to a virtual networking function manager having a processor and a memory; and sending, from the virtual networking function manager, the IP subnet data to a virtual infrastructure manager configured for managing internal and external connectivity of the IP subnet data.

A system includes an operations support system configured for configuring an IP subnet; a virtual networking function, having a memory and a processor, the virtual networking function configured for receiving the IP subnet, wherein the operations support system is further configured for managing the virtual networking function; at least one virtual machine having a memory and a processor, the at least one virtual machine configured for receiving the IP subnet from the virtual networking function and utilizing the IP subnet; a virtual networking function manager having a memory and a processor, the virtual networking function manger configured for receiving IP subnet information from the at least one virtual machine; and a software defined networking controller configured for receiving the IP subnet information from the virtual networking function manager.

A method includes configuring an IP subnet at an operations support system in a telecommunications network, the operations support system including an operator server and being configured for managing a virtual networking function; externally advertising the IP subnet; configuring the IP subnet to the virtual networking function; allocating the IP subnet to at least one virtual machine; utilizing the IP subnet at the at least one virtual machine; sending, from the at least one virtual machine, IP subnet information to a virtual networking function manager; and sending the IP subnet information to at least one controller.

### DESCRIPTION OF THE SEVERAL VIEWS OF THE DRAWINGS

To aid in the proper understanding of the present disclosure, reference should be made to the accompanying drawings, wherein:

FIG. 1 is a diagram illustrating an example ETSI NFV architectural framework, in accordance with the present disclosure;

FIG. 2 is a signal diagram of a first step of a method in accordance with an embodiment of the present disclosure;

FIG. 3 is a signal diagram of a second step of a method in accordance with an embodiment of the present disclosure;

FIG. 4 is a flow chart of a method in accordance with an embodiment of the present disclosure;

FIG. 5 is a flow chart of a method in accordance with an embodiment of the present disclosure; and

FIG. 6 is a diagram illustrating a system in accordance with the present disclosure.

### DETAILED DESCRIPTION

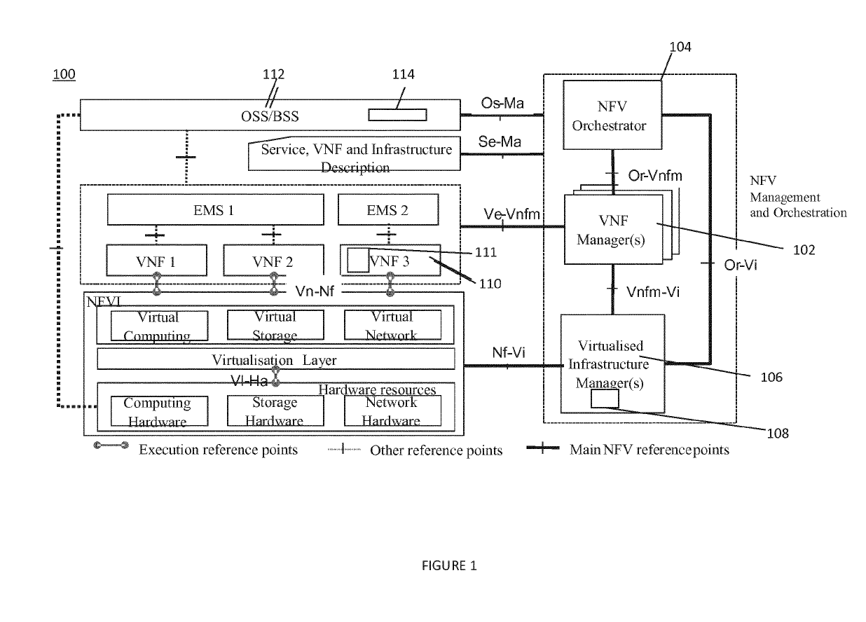

The present disclosure relates to Network Function Virtualization (NFV) environments, and more specifically to Virtual Network Functions (VNFs) that require use and advertisement of multiple IP addresses that are dynamically changing. The present disclosure can be implemented in both IPv4 and IPv6, for example. Referring to FIG. 1, an example architecture of an NFV framework 100 is illustrated. Among other components, the NFV 100 includes a VNF Manager (VNFM) 102 and an NVF Orchestrator (NVFO) 104. The NFV 100 further includes a Virtualized Infrastructure Manager (VIM) 106, which, among other things, collects performance measurements and events is responsible for internal and external connectivity with a network data center (not shown), and which can include a routing controller 108, such as a Software Defined Network (SDN) controller. In the present disclosure, the SDN controller 108 is provided within the VIM 106; however, it is contemplated that the SDN controller 108 could also be a standalone entity or be a part of another component within the NFV framework 100.

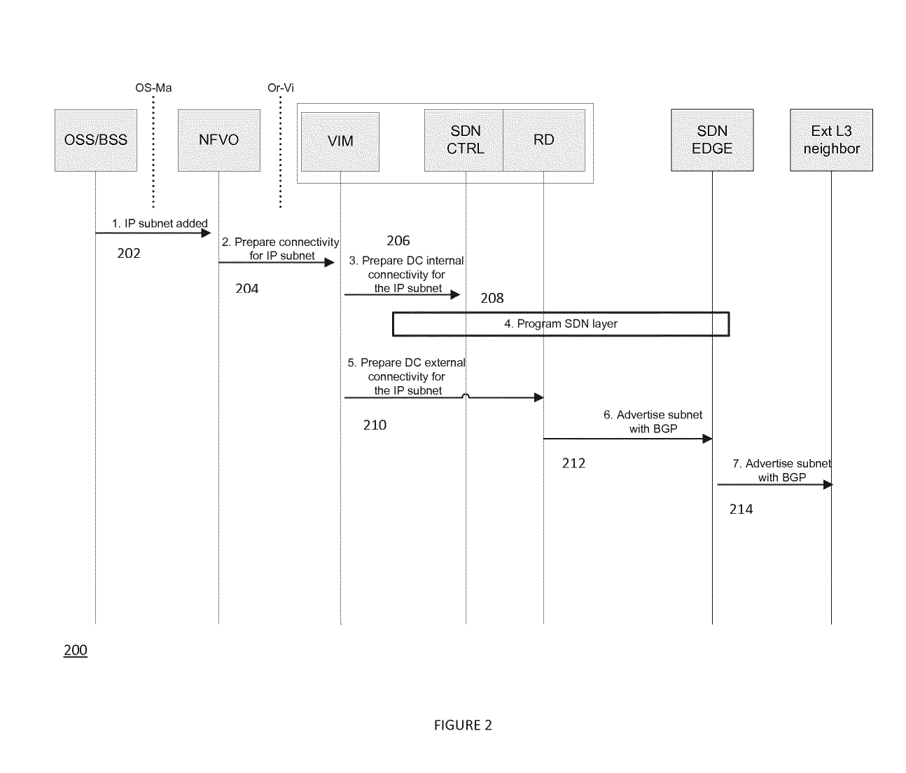

At least one VNF or virtualized network function/element 110 is provided and is configured for communication with the VNFM 102 via a Ve-Vnfm interface. The VNF 110 can include a virtual machine or a container 111. It should be understood that in the present disclosure, the term virtual machine is used in a broad context and refers to an emulation or imitation of a computer system, which can be based on the architecture of a real/hypothetical computer, and which can be implemented in the form of hardware, software, or a combination of both. The actual technology realizing the virtual machine may vary depending on the use case, and can be realized for example with hypervisors or storage containers, as known in the art. As known by those having skill in the art, the VNFM is responsible for the management of one or more VNFs during the lifecycle of the VNF 110 (i.e., from set up to tear down of the VNF). The NVFO manages the network services of the VNF(s) 110, and in cases of more than one VNF, the NVFO creates end-to-end service over the VNFs. Further, the NFV 100 includes an Operations Support System (OSS) 112 that can include an operator server 114. These components will be further described below with respect to FIGS. 2-6.

The conventional method for implementing advertisement of multiple IP addresses is to utilize routing protocols, but in the Network Function Virtualization (NFV) environment, using routing protocols with VNFs is not an optimal solution. Specifically, 3GPP architecture is different than the generic NFV framework 100 of FIG. 1. For example, in traditional 3GPP networks, direct communications between elements is preferred. However, in the NFV architecture, the communication channels are narrowed down to enable higher levels of automation and centralized control points. To address this issue, the present disclosure provides a method and a system for arranging an IP routing service for a VNF that is compliant with the above-described NVF architecture.

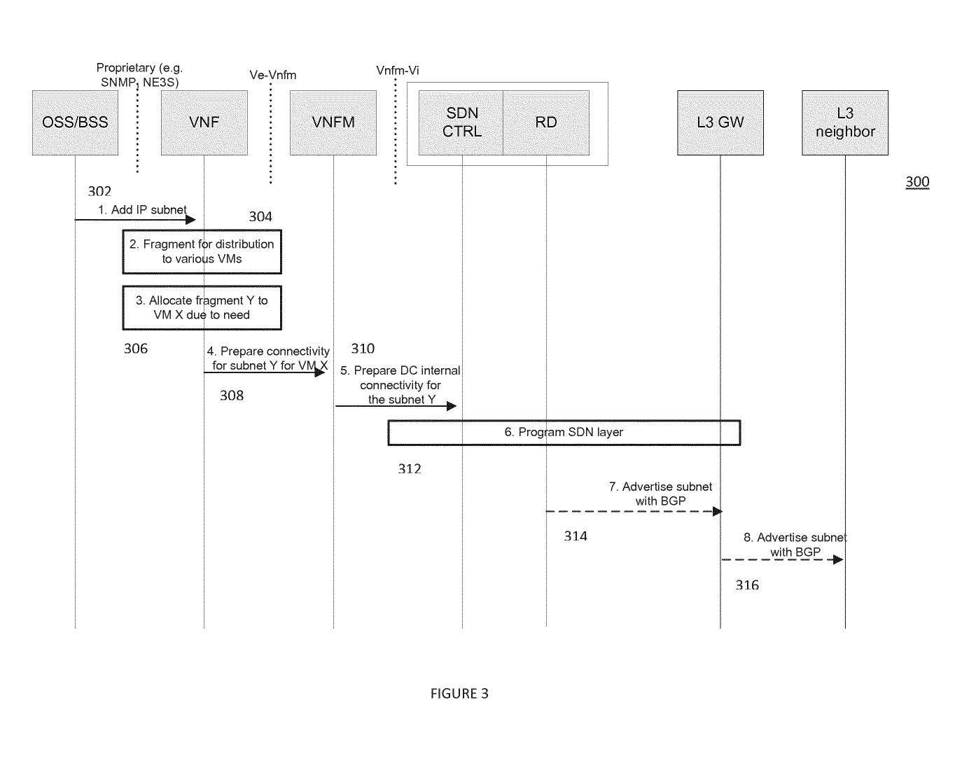

Referring to FIGS. 2-5, the present disclosure provides a method for arranging an IP routing service for the VNF 110 in the NFV framework 100 that does not require a routing function integrated to the VNF. FIGS. 2 and 3 illustrate signal diagrams 200 and 300, respectively, which illustrate a signal flow in accordance with the present disclosure. Signal flow 200 illustrates in detail how an IP subnet can be advertised/routed externally to an SDN EDGE/switch and/or an external L3 neighbor to the network, for example. As known by those having skill in the art, the IP subnet can be a specific routing prefix of an IP address that can be shared by at least one user device or equipment (UE) in a network. At 202, the OSS 112 configures a new IP subnet and sends the IP subnet to the NVFO 104 via an OS-Ma interface, for example (this interface is shown in FIG. 1). Next, the NVFO 104 can arrange for external advertisement/transport of the IP subnet.

Although other signaling paths may be appropriate, in the flow 200, the external advertisement/transport of the IP subnet follows the path NVFO-VIM-SDN CNTRL-RD-Routing Peers. Specifically, at 204, the NFVO 104 communicates with the VIM 106 via interface Or-Vi (see FIG. 1) and prepares connectivity/routing for the IP subnet. At 206, the VIM 106 communicates with the SDN Controller 108 (SDN CNTRL) to prepare Data Center (DC) internal connectivity or routing for the IP subnet. As known in the art, a DC can be a facility used to house computer systems and other related components. At 208, the SDN layer is programmed using a local protocol, such as OpenFlow or NetConf, for example. More specifically, the SDN layer is programmed by configuring transport networking at the SDN controller, by connecting to each switch along a path between the edge device and the virtual machine, and by adding/removing rules for packets/packet flows, for example. This results in a defined path for the packets that match the IP subnet. The VIM 106 communicates with the routing daemon (RD) that can be attached to the SDN Controller 108 and prepares DC external connectivity or routing for the IP subnet at 210. At 212, the routing daemon advertises the IP subnet to a SDN edge, which can then advertise the IP subnet to an external L3 neighbor, for example. As illustrated in FIG. 2, the known Border Gateway Protocol or BGP can be used for the external routing of the IP subnet, but it is appreciated that other similar protocols could be utilized, as known by those having skill in the art.

Turning next to FIG. 3, signaling flow 300 illustrates a dynamic runtime operation that occurs after the external routing/advertisement illustrated in signaling flow 200. Flow 300 can occur within the NFV framework 100. Specifically, at 302, the OSS 112 communicates with the VNF 110 via a proprietary interface (such as, for example, SNMP or NE3S, as known in the art) to add the IP subnet to the VNF. At 304, the VNF 110 divides the IP subnet into at least one fragment, and allocates the fragments (306) to at least one corresponding virtual machine (VM) 111 based on need (i.e., such as when the VM runs out of addresses to give to its present subscribers). The virtual machine 111 can be part of the VNF 110, as shown in FIG. 1. At 308, the VM(s) 111 send IP subnet data about the (ir) respective IP subnet(s) to the VNFM 102. As illustrated in FIG. 3, this data can be sent to the VNFM via a Ve-Vnfm interface. The IP subnet data or information is sent based on need, and accordingly does not need to occur immediately after step 306. At 310, the VNFM 102 prepares DC internal connectivity or routing for the IP subnet by sending the IP subnet data to the SDN Controller 108, which can include an SDN switch. In the present disclosure, the VNFM 102 can communicate with the SDN Controller 108 via the Vnfm-Vi interface, for example. At 312, the SDN layer is programmed using a local protocol, such as OpenFlow or NetConf, similar to step 208 in FIG. 2. Programming the SDN layer provides local data center connectivity. At 314 and 316, the VNFM 102 can further communicate with an external L3 GW or L3 neighbor via the known BGP protocol for example. Such external advertisement/routing of the IP subnet is an optional feature of the present disclosure.

In signal flow 300, the IP subnet data is routed from the VNFM 102 to the VIM 106/SDN 108 via interfaces within the NFV framework, such as the Ve-Vnfm interface between the VNF 110 and the VNFM 102, rather than directly to a service of the VIM (such as a networking controller, for example). As stated above, the proposed routing does not require the VNF 110 to adapt to a particular VIM 106 to which the IP subnet data is sent; rather, the VNFM 102 is configured to adapt to the particular VIM such that the IP subnet data can be sent to the VIM/SDN.

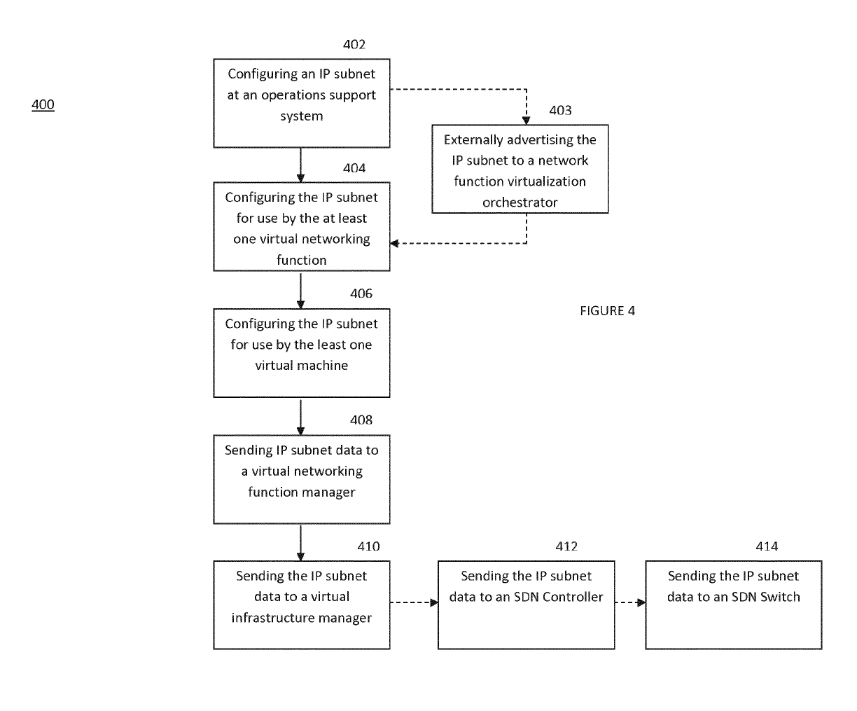

Referring now to FIG. 4, a method 400 is provided in accordance with the present disclosure. The method includes, at 402, configuring an IP subnet at the operations support system (OSS) 112 in a telecommunications network. The operations support system 112 is configured for managing at least one virtual networking function or VNF 110. In accordance with the present disclosure, the IP subnet can be configured at the operator server 114 in the OSS. At 404, the IP subnet is configured for use by the at least one virtual networking function 110. The VNF 110 can include at least one virtual machine (VM) 111 in communication with the telecommunications network and including, for example, a processor and a memory (not shown).

At 406, the IP subnet is configured for use by the least one virtual machine 111. The VNF 110 can be configured to divide the IP subnet into the at least one fragment. Specifically, configuring the IP subnet for use by the at least one virtual machine 111 can include dividing the IP subnet into at least one fragment, and allocating the at least one fragment to the at least one virtual machine. Further, the dividing of the IP subnet can be based on, for example, an operator configurable fragment size, a quantity of available IP addresses at the virtual machine and a quantity of reserved IP addresses at the virtual machine. The dividing of the IP subnet can be based on one or more of the above, and the division is not limited to the above-identified list, as will be appreciated by those having ordinary skill in the art. The VM 111 can then utilize the IP subnet by allocating it to new subscribers that have attached to the network, for example.

At 408, the at least one virtual machine sends IP subnet data to the virtual networking function manager (VNFM) 102, the VNFM having a processor and a memory. The IP subnet data can be sent via the Ve-Vnfm interface between the VNF 110 and the VNFM 102. As briefly stated above, the IP subnet data can include, for example, a routing prefix of the IP address associated with the UE. At 410, the VNFM 102 sends the IP subnet data to the virtual infrastructure manager (VIM) 106. The VIM 106 is configured for managing internal and external connectivity of the IP subnet data.

The method 400 can optionally include, at 403, externally advertising the IP subnet to the network function virtualization orchestrator (NFVO) 104. Specifically, and as described above with reference to FIG. 2, the OSS 112 can communicate with the NFVO 104 via the OS-Ma interface, indicating to the NFVO that the IP subnet has been added/configured. Such external advertising/routing is not required, and it is contemplated that alternative external routing paths may be possible (for example, the SDN switch could automatically start advertising the IP subnets to peers external to the network).

In addition, the method 400 can include sending, from the virtual infrastructure manager 106, the IP subnet data to the software defined networking controller 108 (step 412), and sending, from the software defined networking controller, the IP subnet data to at least one SDN switch (step 414). For example, consider a UE having an IP address “X” allocated from an IP subnet “Y” owned by the VM “Z”. Any packets sent to the UE will travel along a path defined by the SDN controller 108. The SDN controller sends the data to the SDN switch and programs the switch, such that the packets with IP address “X” are allocated to the appropriate VM “Z”.

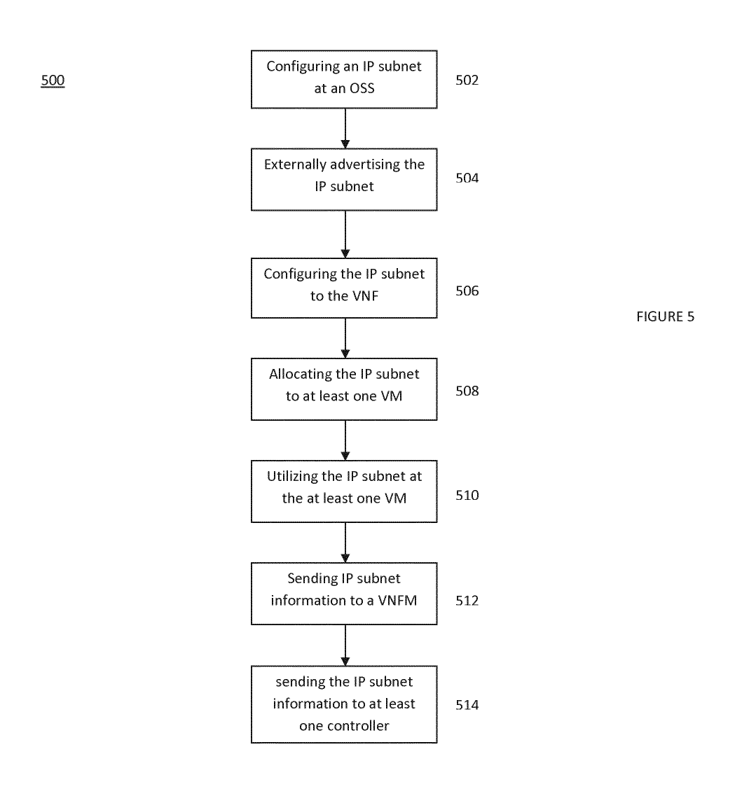

FIG. 5 illustrates another method 500 in accordance with the present disclosure. Specifically, at 502, the IP subnet is configured at the OSS 112. As stated above with respect to FIGS. 1 and 4, the OSS can include the operator server 114, and is configured for managing the VNF 110. At 504, the IP subnet is externally advertised, which includes informing the NFVO 104 of the IP subnet.

The IP subnet, at 506, is configured to the VNF 110. At 508, the IP subnet is allocated to at least one virtual machine 111. Allocating the IP subnet to the at least one virtual machine can include dividing the IP subnet into at least one fragment, and allocating the at least one fragment to the at least one virtual machine. In the present disclosure, the VNF 110 is configured for dividing the IP subnet into the at least one fragment and then allocating the fragment.

At 510, the at least one virtual machine 108 utilizes the IP subnet. Specifically, the at least one virtual machine 108 can utilize the IP subnet by assigning at least one IP address to the IP subnet based on at least one policy configured by the operator. At 512, the at least one virtual machine sends IP subnet information to the VNFM 102 via the Ve-Vnfm interface, and at 514, the VNFM sends the IP subnet information to the at least one controller 108. Sending the IP subnet information to the controller 108 can include, for example, programming at least one software defined networking switch in the controller 108 such that the IP subnet information is sent to the at least one software defined networking switch.

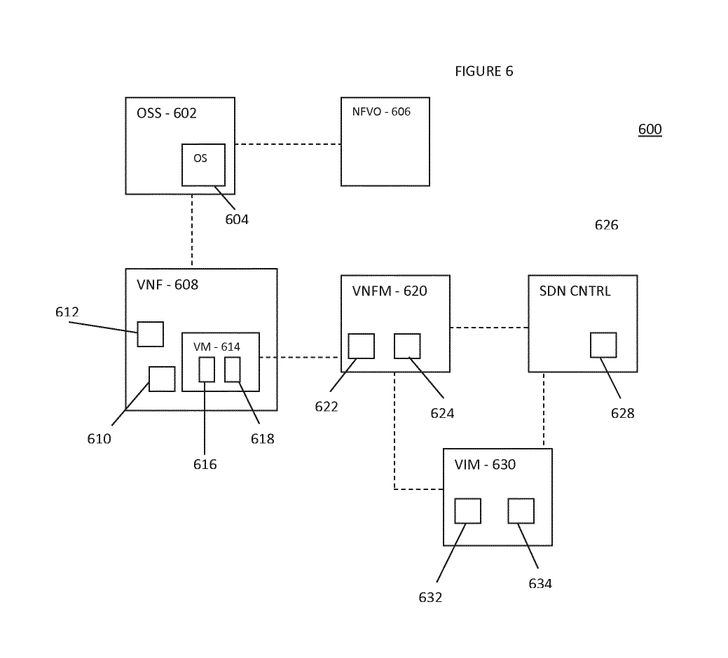

Referring now to FIG. 6, a system 600 is provided in accordance with the present disclosure. The system 600 includes an operations support system 602 for configuring an IP subnet. More specifically, the OSS 602 can include an operator server 604 for configuring the IP subnet. The OSS 602 is further configured to externally advertise the IP subnet to a network function virtualization orchestrator or NFVO 606.

The system 600 further includes a virtual networking function 608 having a memory 610 and a processor 612. The VNF 608 is configured for receiving the IP subnet and can be managed by the OSS 602. At least one virtual machine 614 is also included in the system 600. The virtual machine 614 can include a memory 616 and a processor 618, and is configured for receiving the IP subnet from the virtual networking function 608 and utilizing the IP subnet. The VM 614 can be part of the VNF 608, for example. In addition, the at least one virtual machine can be configured to assign at least one IP address of the configured IP subnet to a user equipment (UE) based on at least one policy configured by the operator server 604.

As described above, the VNF 608 is further configured to divide the IP subnet into at least one fragment and to allocate the at least one fragment to the at least one virtual machine. The IP subnet can be divided into at least one fragment based on an operator configurable fragment size, a quantity of available IP addresses at the virtual machine and a quantity of reserved IP addresses at the virtual machine, for example.

A VNFM 620 is also included in the system 600, and has a memory 622 and a processor 624. As described above with respect to methods 400 and 500, the VNFM 620 is configured for receiving IP subnet information from the at least one virtual machine 614. In addition, the system 600 can include a software defined networking controller 626 configured for receiving the IP subnet information from the virtual networking function manager 620. The SDN controller 626 can program at least one SDN switch 628 to receive the IP subnet information from the virtual networking function manager 620.

Alternatively, the VNFM 620 can send the IP subnet information to a virtual infrastructure manager or VIM 630 having a memory 632 and a processor 634. The VIM 630 can be configured to send the IP subnet information to the SDN controller 626.

The present disclosure provides a method and system that provides architectural consistency to the NFV framework, because the VNF 110 in the present method and system does not directly contact a service of the VIM 106 to send IP subnet data. Rather, the VNFM 102 utilizes specific interfaces to communicate the IP subnet data from the VNF 110 to the VIM 106 and/or SDN Controller 108. Further, the present disclosure provides a method and system that can advertise arbitrary IP subnet data on behalf of the VNF. The present disclosure identifies specific interfaces via which the VNFM can send the IP subnet data, rather than requiring the VNF to communicate directly with the VIM. By utilizing such interfaces, the VNF does not have to include routing capabilities; rather, the VNF can be configured to instruct the VIM/SDN controller regarding the kind of traffic that should be forwarded to a particular VM. The present disclosure also provides a method and system for IP address allocation that has a virtualized network function or VNF, without the need for a routing function.

Embodiments of the present disclosure may be implemented in software (executed by one or more processors), hardware (e.g., an application specific integrated circuit), or a combination of software and hardware. In an example embodiment, the software (e.g., application logic, an instruction set) is maintained on any one of various conventional non-transitory computer-readable media. In the context of this document, a “non-transitory computer-readable medium” may be any media or means that can contain, store, communicate, propagate or transport the instructions for use by or in connection with an instruction execution system, apparatus, or device, such as a computer. A non-transitory computer-readable medium may comprise a computer-readable storage medium (e.g., memory or other device) that may be any media or means that can contain or store the instructions for use by or in connection with an instruction execution system, apparatus, or device, such as a computer. As such, the present disclosure can include a computer program product comprising a computer-readable storage medium bearing computer program code embodied therein for use with a computer, the computer program code comprising code for performing any of the methods and variations thereof as previously described. Further, the present disclosure can also include an apparatus which comprises one or more processors, and one or more memories including computer program code, wherein the one or more memories and the computer program code are configured, with the one or more processors, to cause the apparatus to perform any of the methods and variations thereof as previously described.

If desired, the different functions discussed herein may be performed in a different order and/or concurrently with each other. Furthermore, if desired, one or more of the above-described functions may be optional or may be combined.

Although various aspects of the disclosure are set out in the independent claims, other aspects of the disclosure comprise other combinations of features from the described embodiments and/or the dependent claims with the features of the independent claims, and not solely the combinations explicitly set out in the claims.

It is also noted herein that while the above describes example embodiments of the disclosure, these descriptions should not be viewed in a limiting sense. Rather, there are several variations and modifications which may be made without departing from the scope of the present disclosure as defined in the appended claims.

One having ordinary skill in the art will readily understand that the disclosure as discussed above may be practiced with steps in a different order, and/or with hardware elements in configurations which are different than those which are disclosed. Therefore, although the disclosure has been described based upon these preferred embodiments, it would be apparent to those of skill in the art that certain modifications, variations, and alternative constructions would be apparent, while remaining within the spirit and scope of the invention. In order to determine the metes and bounds of the disclosure, therefore, reference should be made to the appended claims.

The following abbreviations that may be found in the specification and/or the drawing figures are defined as follows:
BGP Border Gateway Protocol
OSS Operations Support Server
NFV Network Function Virtualization
NFVO Network Function Virtualization Operator
RD Routing Daemon
SDN Software Defined Network
UE User Equipment
VIM Virtual Infrastructure Manager
VM Virtual Machine
VNF Virtualized Network Function

1. A method comprising:
configuring an IP subnet at an operations support system in a telecommunications network, the operations support system configured for managing at least one virtual networking function;
configuring the IP subnet for use by the at least one virtual networking function, the virtual networking function including at least one virtual machine;
configuring the IP subnet for use by the least one virtual machine, the at least one virtual machine including a processor and a memory;
sending, from the at least one virtual machine, IP subnet data to a virtual networking function manager having a processor and a memory; and
sending, from the virtual networking function manager, the IP subnet data to a virtual infrastructure manager configured for managing internal and external connectivity of the IP subnet data.

2. The method of claim 1 wherein the IP subnet is configured at an operator server in the operations support system.

3. The method of claim 1 further comprising externally advertising the IP subnet to a network function virtualization orchestrator.

4. The method of claim 1 wherein configuring the IP subnet for use by at least one virtual machine comprises:
at a virtual networking function, dividing the IP subnet into at least one fragment; and
allocating the at least one fragment to at least one virtual machine.

5. The method of claim 4 wherein dividing the IP subnet into at least one fragment is based on at least one of an operator configurable fragment size, a quantity of available IP addresses at the virtual machine and a quantity of reserved IP addresses at the virtual machine.

6. The method of claim 5 further comprising:
sending, from the virtual infrastructure manager, the IP subnet data to a software defined networking controller; and
sending, from the software defined networking controller, the IP subnet data a at least one SDN switch.

7. A method comprising:
configuring an IP subnet at an operations support system in a telecommunications network, the operations support system including an operator server and being configured for managing a virtual networking function;
externally advertising the IP subnet;
configuring the IP subnet to the virtual networking function;
allocating the IP subnet to at least one virtual machine;
utilizing the IP subnet at the at least one virtual machine;
sending, from the at least one virtual machine, IP subnet information to a virtual networking function manager; and
sending the IP subnet information to at least one controller.

8. The method of claim 7 wherein externally advertising the IP subnet comprises informing a network virtualized function operator of the IP subnet.

9. The method of claim 7 wherein allocating the IP subnet to at least one virtual machine comprises:
at the virtual networking function, dividing the IP subnet into at least one fragment; and
allocating the at least one fragment to the at least one virtual machine.

10. The method of claim 7 wherein utilizing the IP subnet at the at least one virtual machine comprises assigning at least one IP address to the IP subnet based on at least one policy configured by the operator.

11. The method of claim 7 wherein sending the IP subnet information to at least one controller further includes programming at least one software defined networking switch in the controller such that the IP subnet information is sent to the at least one software defined networking switch.

12. A system comprising:
an operations support system configured for configuring an IP subnet;
a virtual networking function, having a memory and a processor, the virtual networking function configured for receiving the IP subnet, wherein the operations support system is further configured for managing the virtual networking function;
at least one virtual machine having a memory and a processor, the at least one virtual machine configured for receiving the IP subnet from the virtual networking function and utilizing the IP subnet;
a virtual networking function manager having a memory and a processor, the virtual networking function manger configured for receiving IP subnet information from the at least one virtual machine; and
a software defined networking controller configured for receiving the IP subnet information from the virtual networking function manager.

13. The system of claim 12 wherein the IP subnet is configured at an operator server in the operations support system.

14. The system of claim 13 wherein the operations support system is configured to externally advertise the IP subnet to a network function virtualization orchestrator.

15. The system of claim 12 wherein the virtual networking function is further configured to divide the IP subnet into at least one fragment and to allocate the at least one fragment to the at least one virtual machine.

16. The system of claim 15 wherein the IP subnet is divided into at least one fragment based on at least one of an operator configurable fragment size, a quantity of available IP addresses at the virtual machine and a quantity of reserved IP addresses at the virtual machine.

17. The system of claim 12 wherein the at least one virtual machine is configured to assign at least one IP address to the IP subnet based on at least one policy configured by the operator server.

18. The system of claim 12 wherein the virtual networking function manager is further configured to send the IP subnet information to a virtual infrastructure manager having a memory and a processor.

19. The system of claim 18 wherein the virtual infrastructure manager is configured to send the IP subnet information to the SDN controller.

20. The system of claim 19 wherein the SDN controller is further configured to program at least one SDN switch to receive the IP subnet information from the virtual networking function manager.
